(19) United States
(12) Patent Application Publication
(10) Pub. No.: US 2026/0270925 A1
(43) Pub. Date: Sep. 10, 2026

(54) METHOD FOR RANGING AND/OR SIDELINK POSITIONING CAPABILITY NEGOTIATION, DEVICE AND SOFTWARE

(71) Applicant: Beijing Xiaomi Mobile Software Co., Ltd., Beijing (CN)

(72) Inventor: Yang SHEN, Beijing (CN)

(73) Assignee: Beijing Xiaomi Mobile Software Co., Ltd., Beijing (CN)

(21) Appl. No.: 18/876,602

(22) PCT Filed: Jun. 20, 2022
(86) PCT No.: PCT/CN2022/099962

§ 371 Date: Dec. 18, 2024

(51) Int. Cl. H04W 64/00; H04W 84/04; H04W 92/18

(52) U.S. Cl. CPC H04W 64/00; H04W 84/042; H04W 92/18

(57) ABSTRACT

A ranging and/or sidelink positioning capability negotiation method, a User Equipment (UE) as well as a Location Management Function (LMF) entity and a software. The method comprises: performing a ranging and/or sidelink positioning procedure according to a first ranging and/or sidelink positioning calculation mode indicating a calculating device, wherein the first ranging and/or sidelink positioning calculation mode is determined based on a first ranging/sidelink positioning capability information of at least one UE; in response to detecting a pre-determined event, obtaining a second ranging and/or sidelink positioning capability information of the at least one UE; transmitting the second ranging and/or sidelink positioning capability information of the at least one UE to a Location Management Function, LMF, to determine a second ranging and/or sidelink positioning calculation mode.

### CROSS REFERENCE TO RELATED APPLICATIONS

The present application is a U.S. National Stage of International Application No. PCT/CN2022/099962 filed on Jun. 20, 2022, the content of which is incorporated herein by reference in its entirety.

### TECHNICAL FIELD

The present application generally relates to wireless technology. In particular, the present application relates to a method for ranging and/or sidelink positioning capability negotiation as well as devices and a software for facilitating determining a ranging and/or sidelink positioning result calculation mode. The present application generally relates to wireless technology. In particular, the present application relates to a method for ranging and/or sidelink positioning capability negotiation as well as devices and a software for facilitating determining a ranging and/or sidelink positioning result calculation mode.

### BACKGROUND

Positioning has always been a core part of cellular technology. Sidelink positioning brings flexibility to positioning in different operational scenarios with multiple spectrum options.

As such, there is a need to use wireless communication system such as for example New Radio (NR) cellular technologies to assist in accurate and efficient ranging or sidelink positioning.

Ranging refers to the determination of the distance between two User Equipments (UEs) or more UEs and/or the direction and/or relative positioning of one UE (i.e., Target UE) from another UE (i.e., Reference UE) via PC5 interface. PC5 refers to a reference point where the User Equipment (UE), e.g., mobile handset, directly communicates with another UE over the direct channel. In this case, the communication with the base station is not required. “sidelink positioning” is the terminology to refer to the direct positioning of UE over PC5.

The location management function (LMF) is central in the 5G positioning architecture. The LMF receives measurements and assistance information from the next generation radio access network (NG-RAN) and the mobile device, otherwise known as the user equipment (UE), via the access and mobility management function (AMF) to compute the position of the UE.

Ranging-based services and sidelink positioning consists of distance measurement, direction measurement, or both. UE is allowed to request the distance measurement only, the direction measurement only, or both in the service.

The overall procedure of ranging and/or sidelink positioning of current systems consists of the following steps: receiving ranging and/or sidelink positioning request (e.g., from UE, AMF or LMF); measuring the distance between the 2 UEs or between one UE and multiple UEs; calculating the result (e.g., at UE, at LMF, or at both); and transmitting a response to the ranging and/or sidelink positioning request based on the calculated result (e.g., to UE, AMF, LMF).

As the result calculation can be performed at UE, at LMF or both, they have to be coordinated.

Therefore, challenges of current systems include poor coordination efficiency during the ranging and/or sidelink positioning service. In particular, the calculation mode of the service cannot be adapted dynamically.

Thus, it is an object of the present invention to provide a ranging and/or sidelink positioning capability negotiation method as well as a device and a software enabling improved coordination among entities during the sidelink positioning procedure.

### SUMMARY

In an aspect of the present invention, a method for ranging and/or sidelink positioning capability negotiation is provided, comprising steps: performing a ranging and/or sidelink positioning procedure according to a first ranging and/or sidelink positioning calculation mode indicating a calculating device, wherein the first ranging and/or sidelink positioning calculation mode is determined based at least on a first ranging/sidelink positioning capability information of at least one UE; in response to detecting a first pre-determined event, determining a second ranging and/or sidelink positioning capability information of the at least one UE; transmitting the second ranging and/or sidelink positioning capability information of the at least one UE to a Location Management Function, LMF, to determine a second ranging and/or sidelink positioning calculation mode.

Thus, according to the present invention, a session might be established between the UE and the LMF. In other words, a first ranging and/or sidelink positioning capability information of at least one UE is provided to a network entity (e.g., Access and Mobility Management Function, AMF or LMF). The UE and the LMF may perform a ranging and/or sidelink positioning procedure according to a first ranging and/or sidelink positioning calculation mode determined by the network entity based at least on the previously provided first ranging and/or sidelink positioning capability information of the at least one UE. Thereafter, if a first pre-determined event is detected by the UE (e.g., low power), the UE will determine a second ranging and/or sidelink positioning capability information. Preferably, the second ranging and/or sidelink positioning capability information is determined by updating the first ranging and/or sidelink positioning capability information. Alternatively, the second ranging and/or sidelink positioning capability information might be determined independently from the first ranging and/or sidelink positioning capability information. Then, the second ranging and/or sidelink positioning capability information of the at least one UE is transmitted to an LMF to determine a second ranging and/or sidelink positioning calculation mode. It will be understood that the second ranging and/or sidelink positioning calculation mode may be the same as the first ranging and/or sidelink positioning calculation mode. They could also be different. Therefore, according to the present invention, the UE is able to actively synchronize its ranging and/or sidelink positioning capability information with the LMF so that the LMF could adapt the ranging and/or sidelink positioning calculation mode dynamically.

Preferably, the first pre-determined event is at least one of: switching on power saving mode; switching off power saving mode; usage of at least one central processing unit, CPU, is increased to a predetermined threshold; temperature of the UE is increased to a predetermined threshold; usage of at least one CPU, decreases to the threshold; temperature of the UE decreases to the threshold.

Therein, different situations as described may trigger the UE to determine the second ranging and/or sidelink positioning capability information. For example, switch on/off power saving mode. The power saving mode may refer to a status of a terminal which the background network usage and syncing functions are disabled. If such an event is detected, certain capabilities of the UE might also be changed. Therefore, it is beneficial to make use of such event to trigger the procedure(s). It will be understood that other events may also be suitable triggers. For example, decreasing or increasing the brightness of the screen, disable or enable blue tooth function. Therefore, suitable triggers for determining the second ranging and/or sidelink positioning capability information ensures that the LMF gets the latest capability information of the UE in a timely manner, thereby a more appropriate ranging and/or sidelink positioning calculation mode can be determined.

Preferably, the ranging and/or sidelink capability information comprises at least one of: Capability of calculation of the distance between two UEs; Capability of calculation of the direction of one UE from the other UE; Capability of calculation of high accuracy distance between two UEs; Capability of calculation of high accuracy direction of one UE from the other UE; Capability of calculation of the distance between one UE and each one of the multiple UEs; Capability of calculation of the direction of one UE from each one of the multiple UEs; Capability of calculation of high accuracy distance between one UE and each one of the multiple UEs; Capability of calculation of high accuracy direction from one UE to each one of the multiple UEs.

Therein, different kinds of capability information are provided for a more accurate determination in response to different requests. Preferably, the high accuracy options are defined by the UE. For example, the high accuracy might refer to a horizontal accuracy of less than 10 meters and vertical accuracy less than 3 meters.

Preferably, the method further comprises: receiving a response from the LMF, wherein the response comprises an indication on the second ranging and/or sidelink positioning calculation mode; performing a ranging and/or sidelink positioning procedure according to the second ranging and/or sidelink positioning calculation mode.

After transmitting the second ranging and/or sidelink positioning capability information of the at least one UE, the UE may receive a response from the LMF. The response may be a simple acknowledgement of receipt. The response may also comprise an indication on the second ranging and/or sidelink positioning calculation mode. Thereafter, the UE may perform a ranging and/or sidelink positioning procedure according to the second ranging and/or sidelink positioning calculation mode. It will be understood that the second ranging and/or sidelink positioning calculation mode may be the same as the first ranging and/or sidelink positioning calculation mode. They could also be different.

Preferably, the ranging and/or sidelink positioning calculation mode comprises one of: a UE-based calculation mode, wherein in the UE-based calculation mode the calculating device is at least one UE; an LMF-based calculation mode, wherein in the LMF-based calculation mode the calculating device is a LMF entity; or a hybrid calculation mode, wherein in the hybrid calculation mode the calculating device is at least one UE and the LMF entity.

Preferably, the transmitting the second ranging and/or sidelink positioning capability information of the at least one UE to the LMF is triggered by a second pre-determined event, preferably the second pre-determined event is at least one of: the second ranging and/or sidelink positioning capability information of the at least one UE is different from the first ranging and/or sidelink positioning capability information of the at least one UE; a periodic timer configured on the UE is up; an event indicated in a deferred ranging and/or sidelink positioning request.

Therein, the transmitting of the second ranging and/or sidelink positioning capability information of the at least one UE to the LMF can be triggered by different events. For a periodic request, a periodic timer is configured on the UE, the ranging and/or sidelink positioning procedure starts when the time is up. Therefore, the transmitting of the second ranging and/or sidelink positioning capability information of the at least one UE may be triggered when the periodic timer is up. More preferably, the transmitting of the second ranging and/or sidelink positioning capability information of the at least one UE may be triggered at a predetermined time during each time period of the periodic request. Therefore, the capability information of the UE is always up to date in each period of the periodic request, and the ranging and/or sidelink positioning procedure can be performed immediately according to the newly determined ranging and/or sidelink positioning calculation mode when the periodic timer is up. Preferably, the trigger of the transmitting of the second ranging and/or sidelink positioning capability information of the at least one UE may be an event indicated in a deferred ranging and/or sidelink positioning request. According to the deferred ranging and/or sidelink positioning request, an event is configured on the UE, the ranging and/or sidelink positioning procedure starts when the event happens. For similar considerations as described, the second ranging and/or sidelink positioning capability information of the at least one UE may be transmitted before the ranging and/or sidelink positioning procedure starts. More preferably, when the event happens.

In an aspect of the present invention, a method for ranging and/or sidelink positioning capability negotiation performed by a Location Management Function, LMF, entity, is provided, comprising steps: performing a ranging and/or sidelink positioning procedure according to a first ranging and/or sidelink positioning result calculation mode indicating a calculating device, wherein the ranging and/or sidelink positioning calculation mode is determined based on a first ranging/sidelink positioning capability information of at least one User Equipment, UE; receiving a second ranging and/or sidelink capability information of the at least one UE; determining a second ranging and/or sidelink positioning calculation mode indicating a calculating device based on the second ranging and/or sidelink capability information of the UE.

Therein, according to the present invention, a session might be established between the UE and the LMF. In other words, a first ranging and/or sidelink positioning capability information of at least one UE is provided to a network entity (e.g., Access and Mobility Management Function, AMF or LMF). The UE and the LMF may perform a ranging and/or sidelink positioning procedure according to a first ranging and/or sidelink positioning calculation mode determined by the network entity based on the previously provided first ranging and/or sidelink positioning capability information of the at least one UE. Thereafter, a second ranging and/or sidelink positioning capability information of the at least one UE is by the LMF. Based on the second ranging and/or sidelink positioning capability information of the at least one UE, a second ranging and/or sidelink positioning calculation mode can be determined. It will be understood that the second ranging and/or sidelink positioning calculation mode may be the same as the first ranging and/or sidelink positioning calculation mode. They could also be different. Therefore, according to the present invention, the LMF is able to receive and determine a ranging and/or sidelink positioning calculation mode based on the latest ranging and/or sidelink positioning capability information of the at least one UE.

Preferably, the ranging and/or sidelink positioning calculation mode comprises one of: a UE-based calculation mode, wherein in the UE-based calculation mode the calculating device is at least one UE; an LMF-based calculation mode, wherein in the LMF-based calculation mode the calculating device is a LMF entity; or a hybrid calculation mode, wherein in the hybrid calculation mode the calculating device is at least one UE and the LMF entity.

Preferably, after determining the second ranging and/or sidelink positioning calculation mode, the method further comprises: transmitting a response to the UE, wherein the response comprises an indication on the determined ranging and/or sidelink positioning calculation mode; performing a ranging and/or sidelink positioning procedure according to the second ranging and/or sidelink positioning calculation mode.

After determining the second ranging and/or sidelink positioning calculation mode, the LMF may transmit a response to the UE. The response may be a simple acknowledgement of receipt. The response may also comprise an indication on the second ranging and/or sidelink positioning calculation mode. Thereafter, the LMF may perform a ranging and/or sidelink positioning procedure according to the second ranging and/or sidelink positioning calculation mode. It will be understood that the second ranging and/or sidelink positioning calculation mode may be the same as the first ranging and/or sidelink positioning calculation mode. They could also be different. Furthermore, if the determined ranging and/or sidelink positioning calculation mode is for example, UE-based mode, the step of performing, by the LMF, a ranging and/or sidelink positioning procedure according to the second ranging and/or sidelink positioning calculation mode will not be needed. It will also be understood that if the response does not comprise an indication on the second ranging and/or sidelink positioning calculation mode, the response may be transmitted before the step of determining the second ranging and/or sidelink positioning calculation mode.

In an aspect of the present invention, a User Equipment, UE, is provided comprising: a processor and a memory storage device, wherein in the memory storage device instructions executable by the processor are stored that, when executed, cause the processor to perform the methods for ranging and/or sidelink positioning capability negotiation.

In an aspect of the present invention, a Location Management Function, LMF, entity, is provided comprising: a processor and a memory storage device, wherein in the memory storage device instructions executable by the processor are stored that, when executed, cause the processor to perform the methods for ranging and/or sidelink positioning capability negotiation.

In an aspect of the present invention a non-transitory computer-readable storage medium is provided storing processor-executed instructions that, when executed by a processor, cause the processor to perform the methods for ranging and/or sidelink positioning.

### BRIEF DESCRIPTION OF DRAWINGS

Reference will now be made, by way of example, to the accompanying drawings which show example embodiments of the present application.

FIG. 1 is Sidelink Channels with PC5 Interface.

FIG. 2 is flow diagram illustrating steps of the ranging and/or sidelink positioning negotiation method.

FIG. 3 is an embodiment of the present invention illustrating the procedure of UE initiated ranging and/or sidelink positioning capability negotiation method.

FIG. 4 is a schematic illustration of an LMF entity.

FIG. 5 is a schematic illustration of a UE.

### DETAILED DESCRIPTION

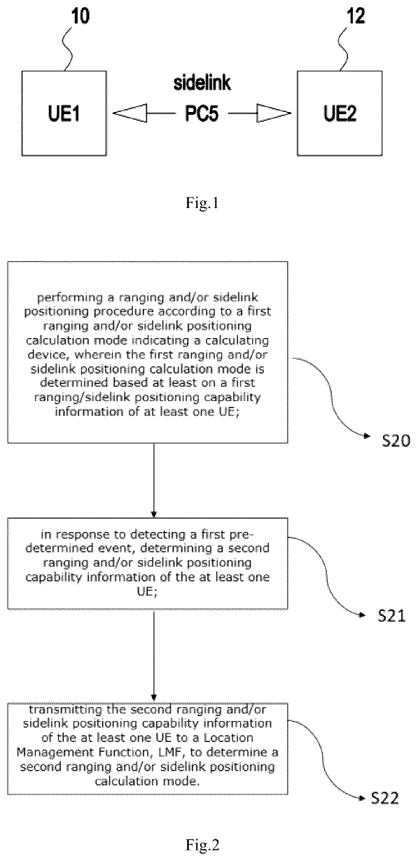

FIG. 1 shows sidelink Channels with PC5 Interface. PC5 refers to a reference point where the User Equipment (UE), UE1, 10, e.g., mobile handset, directly communicates with another UE, UE2, 12 over the direct channel. In this case, the communication with a base station is not required. “sidelink positioning” is the terminology to refer to the direct positioning of UE over PC5.

Referring to FIG. 2, in accordance with the present disclosure, a method for ranging and/or sidelink positioning capability negotiation method is provided and shown in S20-S22.

In step S20, the UE performs a ranging and/or sidelink positioning procedure according to a first ranging and/or sidelink positioning calculation mode indicating a calculating device, wherein the first ranging and/or sidelink positioning calculation mode is determined based at least on a first ranging/sidelink positioning capability information of at least one UE. Preferably, the ranging and/or sidelink positioning procedure is performed collaboratively with an LMF.

In step S21, in response to detecting a pre-determined event, the UE obtains a second ranging and/or sidelink positioning capability information of the at least one UE. Therein, the pre-determined event may be any event that will cause the change of the ranging and/or sidelink positioning capability of the UE (e.g., low power). The UE will obtain a second ranging and/or sidelink positioning capability information. Preferably, the second ranging and/or sidelink positioning capability information is obtained by updating the first ranging and/or sidelink positioning capability information. Alternatively, the second ranging and/or sidelink positioning capability information might be obtained independently from the first ranging and/or sidelink positioning capability information. In particular, the UE may also obtain the ranging and/or sidelink positioning capability information of other UEs (e.g., via PC5 interface).

In step S22, the UE transmits the second ranging and/or sidelink positioning capability information of the at least one UE to a Location Management Function, LMF, to determine a second ranging and/or sidelink positioning calculation mode. It will be understood that the second ranging and/or sidelink positioning calculation mode may be the same as the first ranging and/or sidelink positioning calculation mode. They could also be different. Therefore, according to the present invention, the UE is able to actively synchronize its ranging and/or sidelink positioning capability information with the LMF so that the LMF could adapt the ranging and/or sidelink positioning calculation mode dynamically.

In a preferred embodiment, the pre-determined event is at least one of: switching on power saving mode; switching off power saving mode; usage and/or temperature of at least one central processing unit, CPU, is increased to a predetermined threshold; usage and/or temperature of at least one CPU, decrease to the threshold; a periodic ranging and/or sidelink positioning request is received; a deferred ranging/sidelink positioning request is received. Therein, different situations as described may trigger the UE to obtain the second ranging and/or sidelink positioning capability information. For example, is the usage and/or temperature of the CPU is increased or decreased to a pre-determined value (e.g., CPU usage 70% and/or CPU temperature 60 Centigrade). If such an event is detected, certain capabilities of the UE might also be changed. Therefore, it is beneficial to make use of such event to trigger the procedure as described. It will be understood that other events may also be suitable triggers. For example, decreasing/increasing the brightness of the screen, disable/enable blue tooth function. Therefore, suitable triggers for obtaining the second ranging and/or sidelink positioning capability information ensures that the LMF gets the latest capability information of the UE in a timely manner, thereby a more appropriate ranging and/or sidelink positioning calculation mode can be determined.

In a preferred embodiment, the ranging and/or sidelink capability information comprises at least one of: Capability of calculation of the relative distance between two UEs; Capability of calculation of the relative direction between two UEs; Capability of calculation of high accuracy relative distance between two UEs; Capability of calculation of high accuracy relative direction between two UEs; Capability of calculation of the relative distance between one and multiple UEs; Capability of calculation of the relative direction between one and multiple UEs; Capability of calculation of high accuracy relative distance between one and multiple UEs; Capability of calculation of high accuracy relative direction between one and multiple UEs.

Therein, different kinds of capability information are provided for a more accurate determination in response to different requests. Preferably, the high accuracy options are defined by the UE. For example, the high accuracy might refer to a horizontal accuracy of less than 10 meters and vertical accuracy less than 3 meters.

In a preferred embodiment, the method further comprises: receiving a response from the LMF, wherein the response comprises an indication on the second ranging and/or sidelink positioning calculation mode; performing a ranging and/or sidelink positioning procedure according to the second ranging and/or sidelink positioning calculation mode.

After transmitting the second ranging and/or sidelink positioning capability information of the at least one UE, the UE may receive a response from the LMF. The response may be a simple acknowledgement of receipt. The response may also comprise an indication on the second ranging and/or sidelink positioning calculation mode. Thereafter, the UE may perform a ranging and/or sidelink positioning procedure according to the second ranging and/or sidelink positioning calculation mode. It will be understood that the second ranging and/or sidelink positioning calculation mode may be the same as the first ranging and/or sidelink positioning calculation mode. They could also be different. Further, even if a different ranging and/or sidelink positioning calculation mode is determined, it is possible that the UE which transmitted the second ranging and/or sidelink capability information is not informed about the new calculation mode. It is enough if the LMF and/or other UEs involved in the ranging and/or sidelink positioning calculation is aware of the determined calculation mode.

In a preferred embodiment, the ranging and/or sidelink positioning calculation mode comprises one of: a UE-based calculation mode, wherein in the UE-based calculation mode the calculating device is at least one UE; an LMF-based calculation mode, wherein in the LMF-based calculation mode the calculating device is a LMF entity; or a hybrid calculation mode, wherein in the hybrid calculation mode the calculating device is at least one UE and the LMF entity.

In an aspect of the present invention, a method for ranging and/or sidelink positioning capability negotiation performed by a Location Management Function, LMF, entity, is provided, comprising steps: performing a ranging and/or sidelink positioning procedure according to a first ranging and/or sidelink positioning result calculation mode indicating a calculating device, wherein the ranging and/or sidelink positioning calculation mode is determined based on a first ranging/sidelink positioning capability information of at least one User Equipment, UE; receiving a second ranging and/or sidelink capability information of the at least one UE; determining a second ranging and/or sidelink positioning calculation mode indicating a calculating device based on the second ranging and/or sidelink capability information of the UE.

Therein, according to the present invention, a session might be established between the UE and the LMF. In other words, a first ranging and/or sidelink positioning capability information of the UE is provided to a network entity (e.g., Access and Mobility Management Function, AMF or LMF). The UE and the LMF may perform a ranging and/or sidelink positioning procedure according to a first ranging and/or sidelink positioning calculation mode determined by the network entity based on the previously provided first ranging and/or sidelink positioning capability information of at least one UE. Thereafter, a second ranging and/or sidelink positioning capability information of the at least one UE is received from a UE. Based on the second ranging and/or sidelink positioning capability information of the at least one UE, a second ranging and/or sidelink positioning calculation mode is determined. It will be understood that the second ranging and/or sidelink positioning calculation mode may be the same as the first ranging and/or sidelink positioning calculation mode. They could also be different. Therefore, according to the present invention, the LMF is able to receive and determine a ranging and/or sidelink positioning calculation mode based on the latest ranging and/or sidelink positioning capability information of the at least one UE.

In a preferred embodiment, the ranging and/or sidelink positioning calculation mode comprises one of: a UE-based calculation mode, wherein in the UE-based calculation mode the calculating device is at least one UE; an LMF-based calculation mode, wherein in the LMF-based calculation mode the calculating device is a LMF entity; or a hybrid calculation mode, wherein in the hybrid calculation mode the calculating device is at least one UE and the LMF entity.

In a preferred embodiment, after determining the second ranging and/or sidelink positioning calculation mode, the method further comprises: transmitting a response to the UE, wherein the response comprises an indication on the determined ranging and/or sidelink positioning calculation mode; performing a ranging and/or sidelink positioning procedure according to the second ranging and/or sidelink positioning calculation mode.

After determining the second ranging and/or sidelink positioning calculation mode, the LMF may transmit a response to the UE. The response may be a simple acknowledgement of receipt. The response may also comprise an indication on the second ranging and/or sidelink positioning calculation mode. Thereafter, the LMF may perform a ranging and/or sidelink positioning procedure according to the second ranging and/or sidelink positioning calculation mode. It will be understood that the second ranging and/or sidelink positioning calculation mode may be the same as the first ranging and/or sidelink positioning calculation mode. They could also be different. Further, even if a different ranging and/or sidelink positioning calculation mode is determined, it is possible that the UE which transmitted the second ranging and/or sidelink capability information is not informed about the new calculation mode. It is enough if the LMF and/or other UEs involved in the ranging and/or sidelink positioning calculation is aware of the determined calculation mode. It will also be understood that if the response does not comprise an indication on the second ranging and/or sidelink positioning calculation mode, the response may be transmitted before the step of determining the second ranging and/or sidelink positioning calculation mode.

In an aspect of the present invention, a User Equipment, UE, is provided comprising: a processor and a memory storage device, wherein in the memory storage device instructions executable by the processor are stored that, when executed, cause the processor to perform the method for ranging and/or sidelink positioning capability negotiation.

In an aspect of the present invention, a Location Management Function, LMF, entity, is provided comprising: a processor and a memory storage device, wherein in the memory storage device instructions executable by the processor are stored that, when executed, cause the processor to perform the method for ranging and/or sidelink positioning capability negotiation.

In an aspect of the present invention a non-transitory computer-readable storage medium is provided storing processor-executed instructions that, when executed by a processor, cause the processor to perform the method for ranging and/or sidelink positioning.

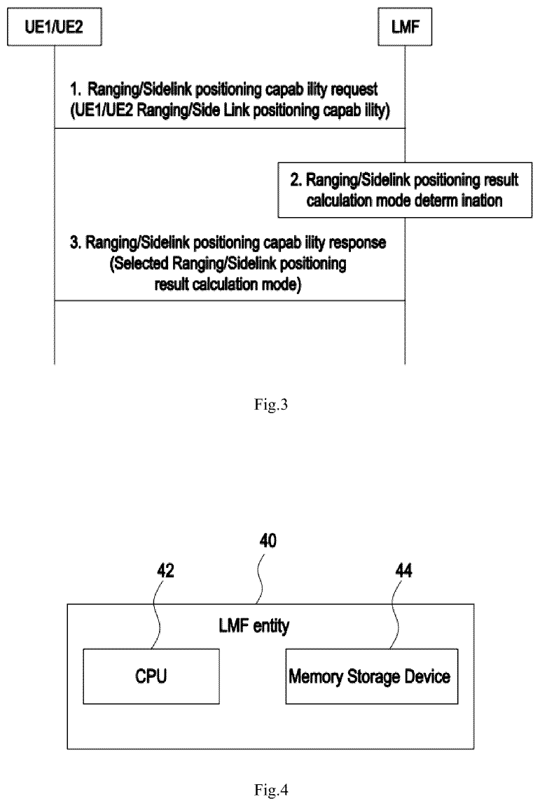

Reference is now made to FIG. 3 which describes a preferred UE initiated ranging/sidelink positioning capability negotiation method according to the present invention.

The procedure described in FIG. 3 may be triggered by a status change of the UE. Any of the pre-determined events described in the present application might be an indication of such a status change and thus, triggers the procedure of FIG. 3.

FIG. 3 shows that if there is already a session established between the UE and the LMF, the UE may wish to update its ranging and/or sidelink positioning capability information upon detecting a pre-determined event (e.g., switching on/off power saving mode). In step 1, the UE initiates the capability negotiation towards the LMF by indicating the updated ranging and/or sidelink positioning capability information of at least one UE. Before initiating the capability negotiation, the UE may obtain the ranging and/or sidelink positioning capability information from other UEs via PC5 interface so that all the relevant positioning capability information may be provided to the LMF by a single UE. In step 2, the LMF receives the ranging and/or sidelink positioning capability information transmitted by the UE, it reevaluates a ranging and/or sidelink positioning calculation mode based on the received information. In step 3, the LMF transmits a response to the UE which may include an indication on the determined ranging and/or sidelink positioning calculation mode. If the response does not include an indication on the determined ranging and/or sidelink positioning calculation mode. The response may also be transmitted before the determination step.

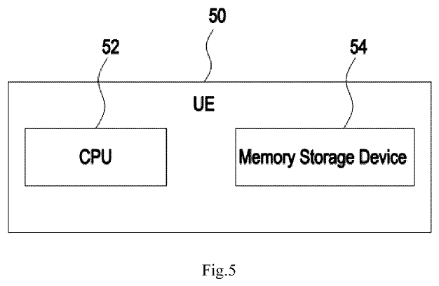

Referring to FIG. 4, which shows a simplified block diagram of an example embodiment of an LMF entity. The LMF entity 40 includes a processor 42 and a memory storage device 44. The memory storage device 44 may store a computer program or application containing instructions that, when executed, cause the processor 42 to perform operations such as those described herein. For example, the instructions may perform methods in accordance with the methods described herein. It will be understood that the instructions may be stored on a non-transitory computer-readable medium, such as a compact disc, flash memory device, random access memory, hard drive, etc. When the instructions are executed, the processor 42 carries out the operations and functions specified in the instructions so as to operate as a special-purpose processor that implements the described process(es). Such a processor may be referred to as a “processor circuit” or “processor circuitry” in some examples.

Referring to FIG. 5, which shows a simplified block diagram of an example embodiment of a UE. The UE 50 includes a processor 52 and a memory storage device 54. The memory storage device 54 may store a computer program or application containing instructions that, when executed, cause the processor 52 to perform operations such as those described herein. For example, the instructions may perform methods in accordance with the methods described herein. It will be understood that the instructions may be stored on a non-transitory computer-readable medium, such as a compact disc, flash memory device, random access memory, hard drive, etc. When the instructions are executed, the processor 52 carries out the operations and functions specified in the instructions so as to operate as a special-purpose processor that implements the described process(es). Such a processor may be referred to as a “processor circuit” or “processor circuitry” in some examples.

The present application also provides a non-transitory computer-readable storage medium storing processor-executed instructions that, when executed by a processor, cause the processor to perform the method in accordance with the methods described herein.

Certain adaptations and modifications of the described embodiments can be made. Therefore, the embodiments are considered to be illustrative and not restrictive. In particular, embodiments can be freely combined with each other.

1. A method for ranging and/or sidelink positioning capability negotiation, implemented by a User Equipment (UE), comprising:
performing a ranging and/or sidelink positioning procedure according to a first ranging and/or sidelink positioning calculation mode indicating a calculating device, wherein the first ranging and/or sidelink positioning calculation mode is determined based at least on a first ranging/sidelink positioning capability information of at least one UE;
in response to detecting a first pre-determined event, determining a second ranging and/or sidelink positioning capability information of the at least one UE; and
transmitting the second ranging and/or sidelink positioning capability information of the at least one UE to a Location Management Function (LMF), to determine a second ranging and/or sidelink positioning calculation mode.

2. The method according to claim 1, wherein the first pre-determined event is at least one of:
switching on a power saving mode,
switching off the power saving mode,
usage of at least one central processing unit (CPU), is increased to a usage threshold,
temperature of the UE is increased to a temperature threshold,
usage of at least one CPU, decreases to the usage threshold, or
temperature of the UE decreases to the temperature threshold.

3. The method according to claim 1, wherein the first ranging and/or sidelink positioning capability information comprises at least one of:
capability of calculation of the distance between two UEs,
capability of calculation of the direction of one UE from the other UE,
capability of calculation of high accuracy distance between two UEs,
capability of calculation of high accuracy direction of one UE from the other UE,
capability of calculation of the distance between one UE and each one of the multiple UEs,
capability of calculation of the direction of one UE from each one of the multiple UEs,
capability of calculation of high accuracy distance between one UE and each one of the multiple UEs, or
capability of calculation of high accuracy direction from one UE to each one of the multiple UEs.

4. The method according to any one of claim 1, further comprises:
receiving a response from the LMF, wherein the response comprises an indication on the second ranging and/or sidelink positioning calculation mode; and
performing a ranging and/or sidelink positioning procedure according to the second ranging and/or sidelink positioning calculation mode.

5. The method according to claim 1, wherein the ranging and/or sidelink positioning calculation mode comprises one of:
a UE-based calculation mode, wherein in the UE-based calculation mode the calculating device is at least one UE,
an LMF-based calculation mode, wherein in the LMF-based calculation mode the calculating device is a LMF entity, or
a hybrid calculation mode, wherein in the hybrid calculation mode the calculating device is at least one UE and the LMF entity.

6. The method according to claim 1, the transmitting the second ranging and/or sidelink positioning capability information of the at least one UE to the LMF is triggered by a second pre-determined event, wherein the second pre-determined event is at least one of:
the second ranging and/or sidelink positioning capability information of the at least one UE is different from the first ranging and/or sidelink positioning capability information of the at least one UE,
a periodic timer configured on the UE is up, or
an event indicated in a deferred ranging and/or sidelink positioning request.

7. A method for ranging and/or sidelink positioning capability negotiation, implemented by a Location Management Function (LMF) entity, comprising:
performing a ranging and/or sidelink positioning procedure according to a first ranging and/or sidelink positioning result calculation mode indicating a calculating device, wherein the first ranging and/or sidelink positioning calculation mode is determined based on a first ranging/sidelink positioning capability information of at least one User Equipment (UE);
receiving a second ranging and/or sidelink capability information of the at least one UE; and
determining a second ranging and/or sidelink positioning calculation mode indicating a calculating device based on the second ranging and/or sidelink capability information of the at least one UE.

8. The method according to claim 7, wherein the ranging and/or sidelink positioning calculation mode comprises one of:
a UE-based calculation mode, wherein in the UE-based calculation mode the calculating device is at least one UE,
an LMF-based calculation mode, wherein in the LMF-based calculation mode the calculating device is a LMF entity, or
a hybrid calculation mode, wherein in the hybrid calculation mode the calculating device is at least one UE and the LMF entity.

9. The method according to claim 7, wherein after determining the second ranging and/or sidelink positioning calculation mode, the method further comprises:
transmitting a response to the UE, wherein the response comprises an indication on the determined ranging and/or sidelink positioning calculation mode; and
performing a ranging and/or sidelink positioning procedure according to the second ranging and/or sidelink positioning calculation mode.

10. A User Equipment (UE) comprising:
a processor; and
a memory storage device storing instructions executable by the processor and cause the processor to perform operations comprising:
performing a ranging and/or sidelink positioning procedure according to a first ranging and/or sidelink positioning calculation mode indicating a calculating device, wherein the first ranging and/or sidelink positioning calculation mode is determined based at least on a first ranging/sidelink positioning capability information of at least one UE;
in response to detecting a first pre-determined event, determining a second ranging and/or sidelink positioning capability information of the at least one UE; and
transmitting the second ranging and/or sidelink positioning capability information of the at least one UE to a Location Management Function (LMF), to determine a second ranging and/or sidelink positioning calculation mode.

11. A Location Management Function (LMF) entity, comprising:
a processor; and
a memory storage device storing instructions executable by the processor and cause the processor to perform the method according to claim 7.

12. A non-transitory computer-readable storage medium storing processor-executed instructions that, when executed by a processor, cause the processor to perform the method according to claim 1.

13. The UE according to claim 10, wherein the first pre-determined event is at least one of:
switching on power saving mode,
switching off power saving mode,
usage of at least one central processing unit (CPU), is increased to a predetermined threshold,
temperature of the UE is increased to a predetermined threshold,
usage of at least one CPU, decreases to the threshold, or
temperature of the UE decreases to the threshold.

14. The UE according to claim 10, wherein the first ranging and/or sidelink positioning capability information comprises at least one of:
capability of calculation of the distance between two UEs,
capability of calculation of the direction of one UE from an other UE,
capability of calculation of high accuracy distance between two UEs,
capability of calculation of high accuracy direction of one UE from the other UE,
capability of calculation of the distance between one UE and each one of a multiple UEs,
capability of calculation of the direction of one UE from each one of the multiple UEs,
capability of calculation of high accuracy distance between one UE and each one of the multiple UEs, or
capability of calculation of high accuracy direction from one UE to each one of the multiple UEs.

15. The UE according to claim 10, wherein the operations further comprise:
receiving a response from the LMF, wherein the response comprises an indication on the second ranging and/or sidelink positioning calculation mode; and
performing a ranging and/or sidelink positioning procedure according to the second ranging and/or sidelink positioning calculation mode.

16. The UE according to claim 10, wherein the ranging and/or sidelink positioning calculation mode comprises one of:
a UE-based calculation mode, wherein in the UE-based calculation mode the calculating device is at least one UE;
an LMF-based calculation mode, wherein in the LMF-based calculation mode the calculating device is a LMF entity; or
a hybrid calculation mode, wherein in the hybrid calculation mode the calculating device is at least one UE and the LMF entity.

17. The UE according to claim 10, wherein transmitting the second ranging and/or sidelink positioning capability information of the at least one UE to the LMF is triggered by a second pre-determined event, and the second pre-determined event is at least one of:
the second ranging and/or sidelink positioning capability information of the at least one UE is different from the first ranging and/or sidelink positioning capability information of the at least one UE,
a periodic timer configured on the UE is up, and
an event indicated in a deferred ranging and/or sidelink positioning request.

18. The LMF entity according to claim 11, wherein the ranging and/or sidelink positioning calculation mode comprises one of:
a UE-based calculation mode, wherein in the UE-based calculation mode the calculating device is at least one UE,
an LMF-based calculation mode, wherein in the LMF-based calculation mode the calculating device is a LMF entity, or
a hybrid calculation mode, wherein in the hybrid calculation mode the calculating device is at least one UE and the LMF entity.

19. The LMF entity according to claim 11, wherein after determining the second ranging and/or sidelink positioning calculation mode, the operations further comprise:
transmitting a response to the UE, wherein the response comprises an indication on the determined ranging and/or sidelink positioning calculation mode, and
performing a ranging and/or sidelink positioning procedure according to the second ranging and/or sidelink positioning calculation mode.

20. A non-transitory computer-readable storage medium storing processor-executed instructions that, when executed by a processor, cause the processor to perform the method according to claim 7.
